(19) United States
(12) Patent Application Publication
(10) Pub. No.: US 2012/0038915 A1
(43) Pub. Date: Feb. 16, 2012

(54) APPARATUS FOR RECEIVING RAMAN SCATTERING SIGNALS AND METHOD OF DOING THE SAME

(76) Inventors: Yasuo TSUCHIDA, Fukuoka (JP); Hirofumi Kawazumi, Fukuoka (JP); Kazuyoshi Arikata, Fukuoka (JP); Akihiro Tsuchida, Fukuoka (JP); Toshiaki Oinuma, Tokyo (JP)

(21) Appl. No.: 13/049,110

(22) Filed: Mar. 16, 2011

(30) Foreign Application Priority Data
Aug. 16, 2010 (JP) JP2010-181806

(51) Int. Cl. G01J 3/44

(52) U.S. Cl. 356/301

(57) ABSTRACT

An apparatus for receiving Raman scattering signals, includes an optic light-collection system for collecting Raman scattering lights having scattered from an object when excitation laser beams are irradiated thereto, a spectroscope including a diffraction grating, for separating the Raman scattering lights into its spectral components, and an optical path converter including at least one optical waveguide for converting lights having been collected by the optic light-collection system into slit-shaped lights in compliance with an orientation of the diffraction grating.

### BACKGROUND OF THE INVENTION

1. Field of the Invention

The present invention relates to an apparatus for receiving Raman scattering signals and a method of doing the same both for obtaining Raman scattering signals which scattered from an object.

2. Description of the Related Art

In treating plastics dumped as domestic and/or industrial wastes, it is often unclear what materials those plastics are composed of. Most of wasted plastics are crushed, and then, incinerated. However, plastics are characterized in that if materials of which plastics are composed (that is, raw materials) were identified, it would be possible to melt and re-mold them, and thus, it would be also possible to reuse them as products with high value added. As an alternative, if plastics to be incinerated contained, for instance, polyvinyl chloride, it would be apprehended that poisonous gases are generated, and thus, it is necessary to know in advance whether polyvinyl chloride is contained.

As one of methods of identifying a material or materials of which wasted plastics are composed, there has been suggested a method in which Raman scattering spectrum is utilized. For instance, Japanese Patent Application Publication No. 2000-356595 suggests a method including the steps of introducing monochrome laser beams emitted from a laser beam source into a fiber head through optical fibers, collectively irradiating the laser beams onto a plastic in a spot, collecting lights which scattered from the plastic, through a fiber head object lens equipped in the fiber head, introducing the thus collected lights into a spectroscope through optical fibers, carrying out spectral analysis to the lights to thereby obtain Raman scattering spectrum, and comparing the spectrum with known band patterns stored in a database to thereby identify a material or materials of which the plastic is composed. Furthermore, the inventors have suggested an apparatus for identifying a plastic, which makes it possible to quickly identify a material or materials of which a plastic is composed, based on Raman scattering, in Japanese Patent No. 4203916.

However, since Raman scattering lights which scattered from an object to be identified is quite weak, a signal obtained is also weak, even if Raman scattering lights are collected through a lens in such a way as mentioned above. Accordingly, it is necessary to raise output power of laser beams for obtaining intensive signals, however, if output power of laser beams were raised, it is apprehended that an object to be identified is damaged. In particular, when an object to be identified is a black plastic, a black plastic tends to absorb laser beams and thus easy to burn, resulting in that it is necessary to keep output power of laser beams low. In addition, since Raman scattering lights which scattered from a black plastic are weak, it is said impossible to identify a material or materials of which a plastic is composed, in a short period of time required in a field of plastic recycling.

### SUMMARY OF THE INVENTION

In view of the above-mentioned problems in the related art, it is an object of the present invention to provide an apparatus for receiving Raman scattering signals and a method of doing the same both of which make it possible to identify an object, even if obtained Raman scattering lights are weak.

In one aspect of the present invention, there is provided an apparatus for receiving Raman scattering signals, including an optic light-collection system for collecting Raman scattering lights having scattered from an object when excitation laser beams are irradiated thereto, a spectroscope including a diffraction grating, for separating the Raman scattering lights into its spectral components, and an optical path converter including at least one optical waveguide for converting lights having been collected by the optic light-collection system into slit-shaped lights in compliance with an orientation of the diffraction grating.

In accordance with the above-mentioned present invention, Raman scattering lights having scattered when excitation laser beams are irradiated to an object are collected within a range in which the excitation laser beams are irradiated, converted into slit-shaped lights in compliance with an orientation of a diffraction grating of the spectroscope through one or more optical waveguide(s), and introduced into the spectroscope. That is, even if Raman scattering lights emitting from an object were weak, the Raman scattering lights are broadly collected within a range in which the excitation laser beams are irradiated, introduced into one or more optical waveguide(s) through an incident end of the optical path converter, converted into slit-shaped lights in compliance with an orientation of a diffraction grating of the spectroscope through one or more optical waveguide(s), introduced into the spectroscope, and separated into its spectral components in the spectroscope.

It is preferable that the optical path converter has an incident end having a shape in compliance with a contour of the Raman scattering lights, in which case, since Raman scattering lights generated by irradiation of excitation laser beams enter the optical path converter at an incident end thereof having a shape in compliance with a contour of the Raman scattering lights, are converted into slit-shaped lights, leave the optical path converter, and are introduced into the spectroscope, ensuring it possible to obtain intensive Raman scattering signals without degradation of resolution to a wavelength or a number of waves, which degradation causes a widened width of Raman scattering peaks.

Herein, a shape of an incident end which is in compliance with a contour of Raman scattering lights generated by irradiation of the excitation laser beams indicates a shape which avoids leakage of Raman scattering lights as much as possible in the case that Raman scattering lights generated by irradiation of excitation laser beams having a shape varied turn into a shape in compliance with the varied shaped of the excitation laser beams.

It is preferable that the optic light-collection system includes a light-collecting lens having an irradiation distance for collecting the Raman scattering lights in compliance with an irradiation contour of the excitation laser beams.

It is preferable that he optic light-collection system further includes an incidence lens which turns lights collected by the optic light-collection system, into a shape in compliance with a shape of an incident end of the optical path converter.

This makes it possible to cause lights collected by the light-collection lens within a range of irradiation of excitation laser beams to enter the optical path convert at an incident end thereof, ensuring that intensive Raman scattering signals can be obtained.

The incidence lens may be comprised of a fly-eye lens, in which case, the incident end of the optical path converter has a shape which is in compliance with the fly-eye lens.

This makes it possible to cause lights entering the fly-eye lens in its wide range to be introduced into the optic spectral system through the optical path converter, ensuring it possible to obtain intensive Raman scattering signals having high resolution.

The apparatus may be designed to further include one of a collimator mirror and a collimator lens for introducing lights emitted out of the optical path converter, into the spectroscope.

Lights having been converted into slit-shaped lights by the optical path converter are further converted into parallel rays by means of a collimator mirror or a collimator lens, and then, introduced into the optic spectral system, ensuring it possible to obtain Raman scattering signals having high resolution.

The apparatus may be designed to further include a slit located downstream of an outlet end of the optical path converter through which lights leave the optical path converter.

Lights having been converted into slit-shaped lights by the optical path converter are introduced into the optic spectral system through the slit, making it possible to remove stray lights, and obtain Raman scattering signals having high resolution.

It is preferable that the excitation laser beams are comprised of narrow-banded laser beams.

By using narrow-banded laser beams having a narrowed wavelength, it is possible to generate Raman scattering lights out of an object with less energy.

For instance, the optical path converter may be designed to include a plurality of optical fibers, wherein one of the optical fibers is centrally located at the incident end of the optical path converter, and the rest of them surround the one of the optical fibers in a circle.

As an alternative, the optical path converter may be designed to include a plurality of optical fibers, wherein the optical fibers are arranged in a matrix.

For instance, the optical fibers may be aligned in a line at an outlet end of the optical path converter.

For instance, the optical fibers may be arranged in alternate two rows in a the form of a slit at an outlet end of the optical path converter.

In another aspect of the present invention, there is provided a method of receiving Raman scattering signals by separating, by means of a spectroscope, Raman scattering lights which an object emits when excitation laser beams are irradiated thereto, into its spectral components to thereby obtain Raman scattering signals, including collecting the Raman scattering lights, converting the thus collected Raman scattering lights into slit-shaped lights in compliance with an orientation of a diffraction grating of the spectroscope, and introducing the Raman scattering lights into the spectroscope.

In the above-mentioned method, it is preferable that the Raman scattering lights are collected in the first step in compliance with a contour of the Raman scattering lights.

The advantages obtained by the above-mentioned present invention are described hereinbelow.

First, Raman scattering lights emitted from an object are broadly collected through the optic light-collection system including the light-collection lens within a range in which the excitation laser beams are irradiated, and the lights thus collected by the optic light-collection system are converted into slit-shaped lights in compliance with an orientation of a diffraction grating of the spectroscope through one or more optical waveguide(s), and then, introduced into the spectroscope. Thus, even if excitation laser beams were irradiated onto an object in a broad range and resultingly Raman scattering lights emitting from the object were weak, it would be possible to obtain intensive Raman scattering signals, and hence, identify the object with high accuracy, ensuring it possible to identify even a black object which tends to absorb laser beams, and resultingly, be damaged.

Second, since the optical path converter is designed to have an incident end having a shape in compliance with a contour of Raman scattering lights generated by irradiation of excitation laser beams, it is possible to obtain intensive Raman scattering signals and hence identify an object with high accuracy without degradation of resolution to a wavelength or a number of waves, which degradation causes a widened width of Raman scattering peaks.

Third, since the optic light-collection system includes an incidence lens which irradiates lights collected by the optic light-collection system, in compliance with the shape of the incident end of the optical path converter, it is possible to cause lights broadly collected by the light-collection lens within a range of irradiation of excitation laser beams to enter the optical path converter at its incident end, ensuring that intensive Raman scattering signals can be obtained, and an object can be identified with high accuracy.

Fourth, since the apparatus includes a slit located downstream of an outlet end of the optical path converter through which lights leave the optical path converter, lights having been converted into slit-shaped lights by the optical path converter are introduced into the optic spectral system through the slit, making it possible to remove stray lights, obtain Raman scattering signals having high resolution, and identify an object with high accuracy.

Fifth, by using narrow-banded laser beams as the excitation laser beams, it is possible to generate Raman scattering lights out of an object with less energy, ensuring that a black object which tends to absorb laser beams is hard to be damaged.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a schematic view illustrating a structure of an apparatus for identifying a plastic in accordance with an embodiment of the present invention.

FIG. 2 is a block diagram of an apparatus for identifying Raman scattering, which is a part of the apparatus illustrated in FIG. 1.

FIG. 3 illustrates a structure of an apparatus for receiving Raman scattering signals, which is a part of the apparatus for identifying Raman scattering, illustrated in FIG. 2.

FIG. 4A is a cross-sectional view taken along the line A-A in FIG. 3.

FIG. 4B is a cross-sectional view taken along the line B-B in FIG. 3.

FIG. 5 illustrates a structure of an apparatus for receiving Raman scattering signals, in accordance with another embodiment.

FIG. 6A is a cross-sectional view taken along the line A-A in FIG. 5.

FIG. 6B is a cross-sectional view taken along the line B-B in FIG. 5.

FIG. 7 illustrates an example of Raman scattering spectrum for a known plastic.

FIG. 8 illustrates an example of PS identification accomplished by the identification means.

FIG. 9A is a perspective view of another example of an optical path converter.

FIG. 9B is a plan view of the optical path converter illustrated in FIG. 9A.

FIG. 9C is a side view of the optical path converter illustrated in FIG. 9A.

### DESCRIPTION OF THE PREFERRED EMBODIMENTS

Preferred embodiments in accordance with the present invention will be explained hereinbelow with reference to drawings.

### First Embodiment

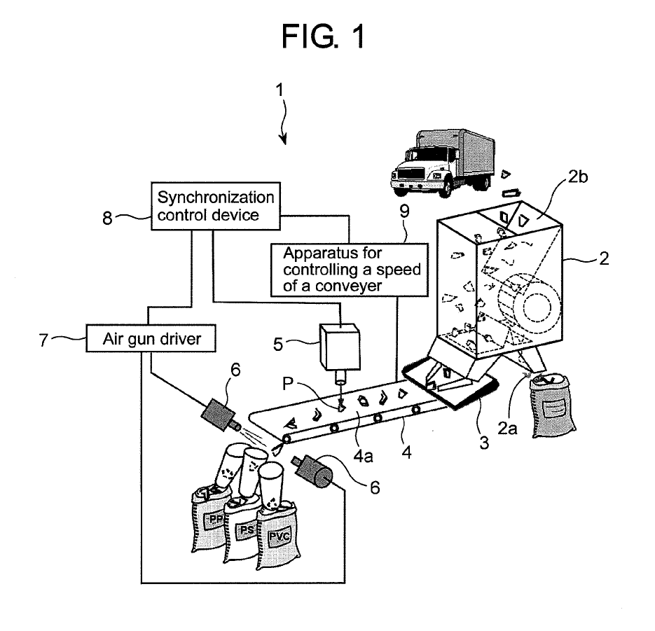

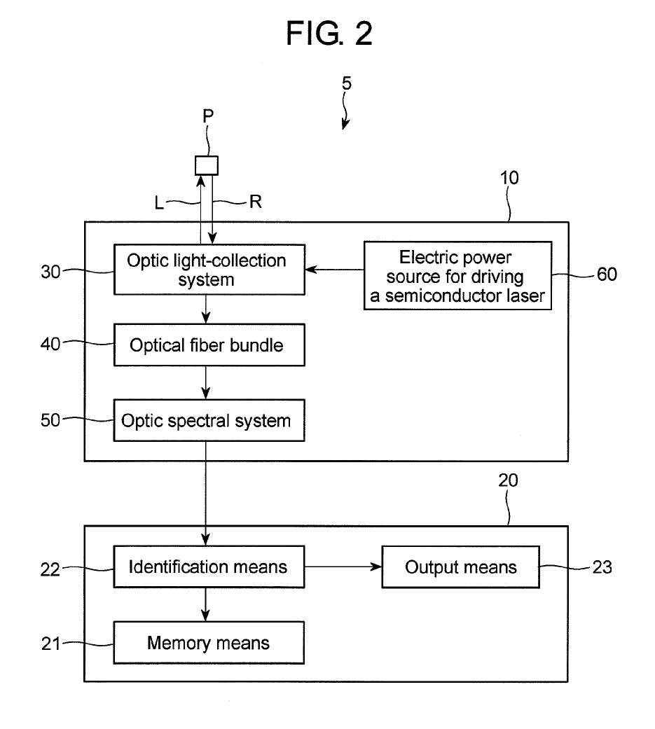

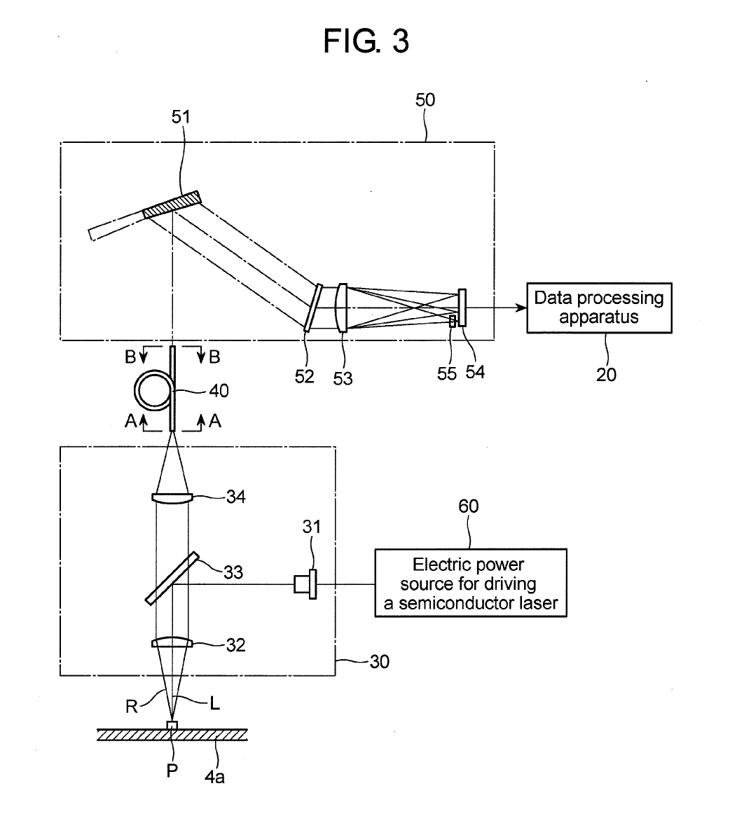

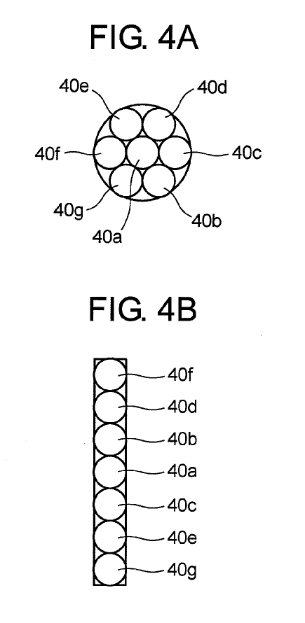

FIG. 1 is a schematic view illustrating a structure of an apparatus for identifying a plastic in accordance with an embodiment of the present invention FIG. 2 is a block diagram of an apparatus for identifying Raman scattering, which is a part of the apparatus illustrated in FIG. 1, FIG. 3 illustrates a structure of an apparatus for receiving Raman scattering signals, which is a part of the apparatus for identifying Raman scattering, illustrated in FIG. 2, FIG. 4A is a cross-sectional view taken along the line A-A in FIG. 3, and FIG. 4B is a cross-sectional view taken along the line B-B in FIG. 3.

In FIG. 1, an apparatus 1 for identifying a plastic as an apparatus for identifying an object in accordance with Raman scattering, in accordance with the first embodiment of the present invention, includes a pre-treatment facility 2 such as a wind-force screening machine or a specific gravity screening machine for screening crushed plastics into plastic pieces P and foreign materials 2a, the pre-treatment facility 2 having an inlet 2b through which crushed plastics are introduced thereinto, an oscillation-alignment feeder 3 which oscillates plastic pieces having been screened by the pre-treatment facility 2 to thereby arrange them in a line, a belt conveyer 4 as a carrier for carrying plastic pieces having been arranged in a line by the oscillation-alignment feeder 3 with the plastic pieces being laid on a belt 4a acting as a carriage platform, and an apparatus 5 for identifying Raman scattering, which irradiates laser beams onto plastic pieces lying on the belt conveyer 4, that is, an object to be identified, receives Raman scattering lights scattering from the plastic pieces, and identify a raw material and a quality of the plastic pieces.

The apparatus 1 for identifying a plastic further includes a screening air gun 6 which spurts compressed air in accordance with results of the identification accomplished by the apparatus 5 for identifying Raman scattering to thereby screen the plastic pieces in accordance with a raw material and a quality, an air gun driver 7 for driving the screening air gun 6, an synchronization control device 8 for synchronizing operations of the apparatus 5 for identifying Raman scattering and the air gun driver 7, and an apparatus 9 for controlling a speed of a conveyer, which controls a carriage speed of the belt conveyer 4. The synchronization control device 8 synchronizes an operation of the apparatus 9 for controlling a speed of a conveyer with the operations of the apparatus 5 for identifying Raman scattering and the air gun driver 7.

As illustrated in FIG. 2, the apparatus 5 for identifying Raman scattering includes an apparatus 10 for receiving Raman scattering signals which scattered from the plastic P to be identified, and a data processing apparatus 20 which processes Raman scattering signals received from the apparatus 10.

As illustrated in FIG. 2, the apparatus 10 for receiving Raman scattering signals includes, as mentioned below, an optic light-collection system 30, a bundle of optical fibers 40 acting as optical path converters, an optic spectral system 50, and an electric power source 60 for driving a semiconductor laser.

As illustrated in FIG. 3, the optic light-collection system 30 irradiates laser beams L onto a target plastic P lying on the belt 4a, and collects both Raman scattering lights having scattered from the target plastic P and laser beams having reflected at the target plastic P. Lights having been collected by the optic light-collection system 30 are introduced into the optic spectral system 50 through the optical fiber bundles 40.

Electrical signals output from the optic spectral system 50 are input into and processed in the data processing apparatus 20. The electric power source 60 for driving a semiconductor laser drives a later-mentioned apparatus 31 for generating semiconductor laser.

As illustrated in FIG. 3, the optic light-collection system 30 includes an apparatus 31 for generating semiconductor laser, which generates excitation laser beams L to be irradiated onto the plastic P to be identified, that is, an object to be identified, a light-collection lens 32 comprised of a plain convex lens for irradiating the laser beams L onto the plastic P to be identified, and collecting Raman scattering lights R having scattered from the plastic to be identified, a dichroic mirror 33 which reflects the laser beams L emitted from the semiconductor-laser generating apparatus 31 and directs the reflected laser beams to the light-collection lens 32, and further, allows the Raman scattering lights R to pass therethrough, and an incidence lens 34 comprised of a plain convex lens for collecting the Raman scattering lights R having passed through the dichroic mirror 33, and causing the Raman scattering lights R to enter the optical fiber bundles 40.

The light-collection lens 32 allows the laser beams L generated by the semiconductor-laser generating apparatus 31 to be irradiated onto the target plastic P in a widened spot size so as to prevent the target plastic P from being damaged even if the target plastic P is black, and is designed to have an adjusted irradiation distance so as to collect lights in a broad range in compliance with a contour of irradiation of the laser beams L.

Though the semiconductor-laser generating apparatus 31 may be designed to generate ordinary laser beams, it is preferable that it is designed to generate narrow-banded laser beams having a narrowed wavelength, if the plastic P to be identified is black.

Furthermore, though the laser beams L are coaxially irradiated by means of the light-collection lens 32 collecting the Raman scattering lights R, it is not always necessary to do so. The laser beams L may be irradiated in another direction.

Each of the light-collection lens 32 and the incidence lens 34 in the optic light-collection system 30 may be comprised of a plurality of plain convex lenses. The optic light-collection system 30 may be designed to further include a mirror between the semiconductor laser generating apparatus 31 and the dichroic mirror 33. The dichroic mirror 33 may be replaced with a half mirror which reflects the laser beams L, but allows the Raman scattering lights R to pas therethrough. The optic light-collection system 30 may be designed to further include a band path filter and/or a long path filter.

The optical fiber bundle 40 introduces the lights having been collected by the incidence lens 34 into the optic spectral system 50, and is comprised of a plurality of optical fibers 40a, 40b, 40c, 40d, 40e, 40f and 40g each acting as an optical wave guide.

As illustrated in FIG. 4A, the optical fiber bundle 40 has an incident end comprised of the optical fiber 40a, and the optical fibers 40b to 40g surrounding the optical fiber 40a in a circle. The incidence lens 34 irradiates lights having been collected by the light-collection lens 32, in compliance with the arrangement of the optical fiber bundle 40 at the incident end.

In contrast, as illustrated in FIG. 4B, the optical fiber bundle 40 has an outlet end comprised of the optical fibers 40a to 40g arranged in a line in the form of a slit such that the optical fibers are parallel with an orientation of a diffraction grating (slit) of a later-mentioned spectroscope 52.

As illustrated in FIG. 3, the optic spectral system 50 includes a collimator mirror 51 turning lights having been emitted from the optical fiber bundle 40 into a bundle of parallel lights, a spectroscope 52 such as a light-transmission type diffraction grating for separating lights having passed through the collimator mirror 51, into its spectral components, a mitre lens 53, and a photodetector 54 which converts lights having passed through the spectroscope 52 into electrical signals.

The lights having left the optical fiber bundle 40 enter the collimator mirror 51 at a portion located out of an optical axis of a paraboloid of the collimator mirror 51. The mitre lens 53 focuses lights having passed through the spectroscope 52 on the photodetector 54.

The photodetector 54 is comprised of, for instance, a two-dimensional photodetector having 1024 pixels therein, such as CCD (Charge Coupled Device) or a linear array photodiode. Raman scattering lights R having passed through the spectroscope 52 are introduced into a majority part of pixels of the photodetector 54. The Raman scattering lights R having entered the photodetector 54 are converted into electrical signals by the photodetector 54, and then, transmitted to the data processing apparatus 20.

A part of the laser beams L passes through the dichroic mirror 33, and then, is collected at an incident end of the optical fiber bundle 40. The laser beams L are directed into a minority part of pixels of the photodetector 40. An extinction filter 55 is located upstream of the photodetector 54 into which the laser beams L are introduced. After extincted in the extinction filter 55, the laser beams L are converted into electrical signals in the photodetector 54, and then, introduced into the data processing apparatus 20.

In the optic spectral system 50, the collimator mirror 51 may be replaced with a collimator lens, and the spectroscope 52 may be comprised of a reflection-type diffraction grating. Furthermore, the optic spectral system 50 may be designed to further include one or more mirrors and/or lenses. Even when the spectroscope 52 is comprised of a reflection-type diffraction grating, an outlet end of the optical fiber bundle 40 is designed to be parallel with an orientation of the diffraction grating (grooves).

The data processing apparatus 20 may be comprised of a personal computer or a CPU board, and is electrically connected to the apparatus 10 for receiving Raman scattering signals, for instance, through PCI (Peripheral Component Interconnect) interface.

As illustrated in FIG. 2, the data processing apparatus 20 includes memory means 21 for storing predetermined references and so on, identification means 22 for identifying a material of which the plastic P is composed, in accordance with Raman scattering data, and output means 23 for outputting the results of the identification.

References stored in the memory means 21 include Raman scattering intensities at one or more known peak location(s) and known base line location(s) both of which were determined by measuring Raman scattering spectrums for plastics to be identified, for instance, each of known plastic materials such as PMMA (polymethylmethacrylate), PC (polycarbonate), PS (polystyrene), PP (polypropylene), PET (polyethylene terephthalate), PVC (polyvinyl chloride), ABS resin (acrylonitrile•butadiene•styrene copolymer synthetic resin), LDPE (low-density polyethylene) and HDPE (high-density polyethylene).

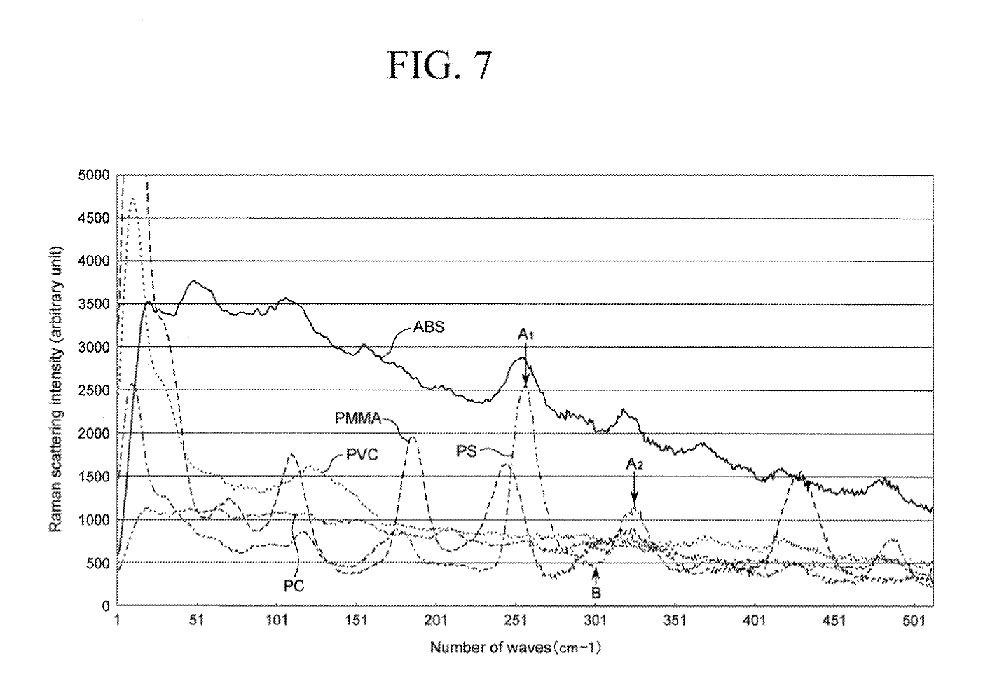

FIG. 7 shows the results of obtaining Raman scattering spectrums for each of known plastics (PMMA, PC, ABS, PS, PVC) as reference materials, by means of the apparatus 1 for identifying a plastic, in accordance with the first embodiment of the present invention. In FIG. 7, an axis of abscissa indicates a number of Raman shift waves [cm⁻¹], and an axis of ordinates indicates Raman scattering intensity (arbitrary intensity).

In FIG. 7, PS is explained hereinbelow as an example. In PS, since there are peaks at points A₁ and A₂, points A₁ and A₂ or in the neighborhood thereof are defined as a peak location used for PS identification. Furthermore, since a point B which is in the level of base line is located between the points A₁ and A₂, a point B is defined as a base line location used for PS identification.

It is preferable to select, as a base line location and a base line intensity, bottom location and intensity which is not so remote from a peak location, and at which Raman scattering intensity is weak. As an intensity, there may be used an average of measured intensities of an area including a peak location, a base line location and neighborhood thereof. By using such an average, it is possible to enhance a SN ratio.

The identification means 22 receives, from the apparatus 10 for receiving Raman scattering signals, both Raman scattering intensity associated with a number of Raman shift waves for a known peak location(s) (points A₁ and A₂ in the example PS) of each of materials of which a plastic to be identified is composed, and Raman scattering intensity associated with a number of Raman shift waves for a known base line location (point B in the example PS).

Since Raman scattering spectrum varies in dependence on fluctuation in a wavelength and an intensity of the laser beams L, the identification means 22 calculates Raman scattering intensity for a certain number of Raman shift waves, and a wavelength and an intensity of the laser beams, based on electrical signals received from the apparatus 10 for receiving Raman scattering signals, and then, amends Raman scattering intensity. The identification means 22 identifies a material of which the target plastic P is composed, in accordance with both the thus obtained Raman scattering intensity and a reference stored in the memory means 21.

For instance, the identification means 22 identifies a plastic(s) of which the target plastic is composed, by directly comparing differences (R_{A1}−R_{B}) and (R_{A2}−R_{B}) between Raman scattering intensities R_{A1}, R_{A2} for a number of Raman shift waves associated with the known peak locations (points A₁, A₂) for each of materials of a plastic to be identified, and Raman scattering intensity R_{B} for a number of Raman shift waves associated with the known base line location (point B), with differences (RA₁₀−R_{B0}) and (R_{A20}−R_{B0}) between Raman scattering intensities R_{A10}, R_{A20} for the known peak location of a known plastic(s) as reference intensities, and Raman scattering intensity R_{B0} for a known base line location, or by comparing them with each other through ratios (R_{A1}−R_{B})/(R_{A2}−R_{B}) and (R_{A10}−R_{B0})/(R_{A20}−R_{B0}) thereof. The references (R_{A10}−R_{B0}) and (R_{A20}−R_{B0}) to be used in the direct comparison, and the references (R_{A10}−R_{B0})/(R_{A20}−R_{B0}) to be used in the comparison made through ratios are in advance stored in the memory means 21.

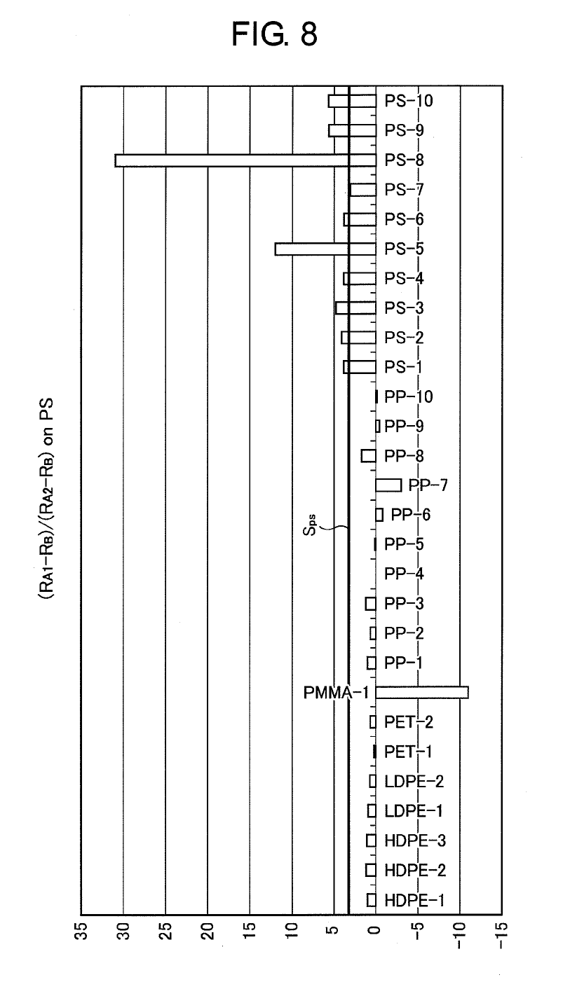

FIG. 8 shows an example of PS identification accomplished by the identification means 22.

As illustrated in FIG. 8, the ratio (R_{A1}−R_{B})/(R_{A2}−R_{B}), wherein (R_{A1}−R_{B}) and (R_{A2}−R_{B}) indicate differences between Raman scattering intensities R_{A1}, R_{A2} for a number of Raman shift waves associated with the known peak locations of the points A₁, A₂ for PS, and Raman scattering intensity R_{B} for a number of Raman shift waves associated with the known base line location of the point B, is significantly different from other ratios for other materials. Accordingly, it is possible to identify PS and take PS only out of mixture samples containing PMMA, PS, PP, PET, LDPE and HDPE, by filtering with a threshold S_{PS} as a reference defined based on a ratio (R_{A10}−R_{B0})/(R_{A20}−R_{B0}), wherein (R_{A10}−R_{B0}) and (R_{A20}−R_{B0}) are differences between Raman scattering intensities R_{A10}, R_{A20} for the known peak location of PS, and Raman scattering intensity R_{B0} for the known base line location of PS (in FIG. 8, sampling only (R_{A10}−R_{B0}), (R_{A20}−R_{B0})>S_{PS}=2.5).

Though not illustrated, it is similarly possible with respect to other plastics to identify a material or materials of which a target plastic is composed, in accordance with a difference or a ratio between Raman scattering intensity for a number of Raman shift waves associated with a know peak location thereof, and Raman scattering intensity for a number of Raman shift waves associated with a known base line location thereof.

In the apparatus 1 for identifying a plastic, having such a structure as mentioned above, crushed plastics (which may contain foreign materials) are screened into foreign materials and plastic pieces by the pre-treatment facility 2, and the thus screened plastic pieces are oscillated by the oscillation-alignment feeder 3 to thereby lay in a line, and then, carried on the belt conveyer 4. Then, the apparatus 5 for irradiating Raman scattering irradiates laser beams onto the target plastic P lying on the belt 4a of the belt conveyer 4 to thereby identify a material of which the plastic P is composed. The plastics are screened with respect to a material by the screening air gun 6 in accordance with the results of the identification. The results of the identification are output to the output means 23.

In the apparatus 10 for receiving Raman scattering signals, which is a part of the apparatus 5 for identifying Raman scattering, the laser beams L emitted from the laser beam source, that is, the semiconductor laser generating apparatus 31 are collectively irradiated onto a surface of the target plastic P through the light-collection lens 32 in a broad area, and Raman scattering lights R having scattered from the target plastic P are broadly collected by the light-collection system 30 in a range in which the laser beams L were irradiated. Then, the Raman scattering lights R are introduced into the optical fiber bundle 40 in which optical fibers are bundled in a circle at an incident end. The lights enter not only the centrally located optical fiber 40a, but also the optical fibers 40b to 40g surrounding the optical fiber 40a, and then, leave the optical fiber bundle 40 at an outlet end in the form of a slit. Then, the lights are introduced into the optic spectral system 50.

Thus, even if Raman scattering lights R having scattered from the target plastic P were weak, it would be possible to obtain intensive Raman scattering signals, because Raman scattering lights R are caused to enter the optical fiber bundle 40 including a plurality of optical fibers 40a to 40g bundled in a circle, and introduced as slit-shaped lights into the optic spectral system 50 without loss.

The optical fiber bundle 40 has an outer diameter of 0.1 mm or greater, preferably 0.5 mm or greater, and makes it possible to obtain intensive Raman scattering signals, even if the incidence lens 34 is not slightly accurately focused. Thus, even if the target plastic P were black one, and the laser beams L were irradiated onto the target plastic in a broad range, it would be possible to obtain intensive Raman scattering signals, and hence, identify the target plastic P.

In the apparatus 5 for identifying Raman scattering, the laser beams having reflected at the target plastic P is introduced further into the photodetector 54 to thereby amend Raman scattering data, and the target plastic P is identified based on the thus amended Raman scattering data. Since the amended Raman scattering data can be obtained only by referring to predetermined peak location and base line location, it is not necessary to accurately measure Raman scattering spectrum in its entirety unlike a conventional way.

### Second Embodiment

Hereinbelow is explained an apparatus for receiving Raman scattering signals, in accordance with the second embodiment of the present invention.

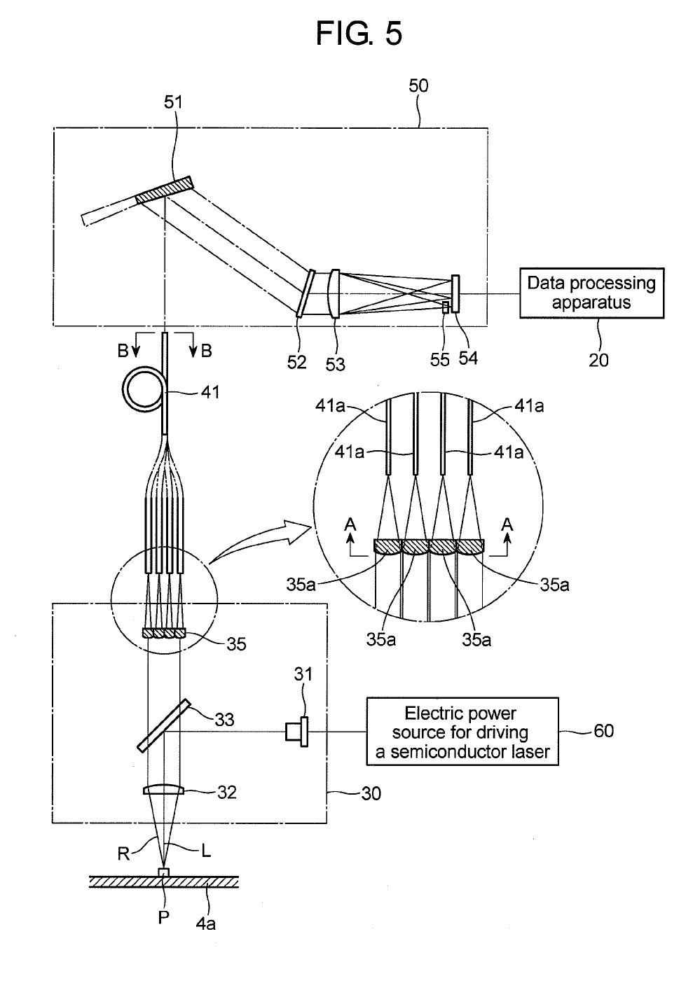

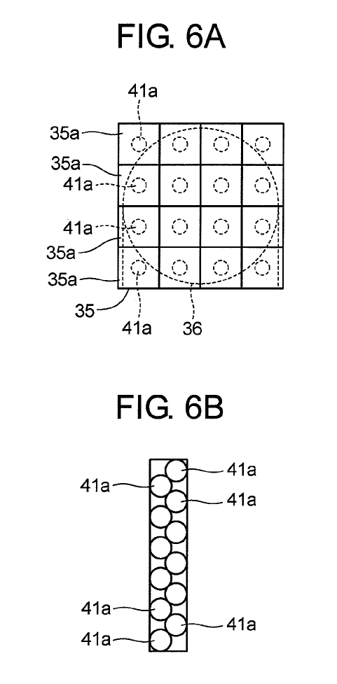

FIG. 5 illustrates a structure of an apparatus for receiving Raman scattering signals in accordance with the second embodiment, FIG. 6A is a cross-sectional view taken along the line A-A in FIG. 5, and FIG. 6B is a cross-sectional view taken along the line B-B in FIG. 5.

The apparatus 10 for receiving Raman scattering signals, illustrated in FIG. 5, is designed to include, in place of the incidence lens 34, a fly-eye lens 35 comprised of plain convex lenses 35a all of which are identical with one another and which are arranged in a matrix (see FIG. 6A), and further include, in place of the optical fiber bundle 40, an optical fiber bundle 41 in which optical fibers are bundled at an incident end thereof in a shape in compliance with the fly-eye lens 35. Specifically, each of incident ends of a plurality of optical fibers 41a defining the optical fiber bundle 41 is situated on each of optical axes of a plurality of plain convex lenses 35a defining the fly-eye lens 35, and the optical fibers 41a are bundled in a square at incident ends thereof.

As illustrated in FIG. 6B, the optical fibers are bundled in alternate two rows in a slit at an outlet end of the optical fiber bundle 41.

The structure except above-mentioned is identical to that of FIG. 3.

In the structure as mentioned above, Raman scattering lights R having scattered from the target plastic P are collected by the optic light-collection system, and then, introduced through the fly-eye lens 35 into each of the optical fibers 41a bundled in a square at an incident end of the optical fiber bundle 41. That is, since the structure allows lights 36 (see FIG. 6A) entering the fly-eye lens 35 in a broad area to be turned into alternate two rows by the optical fiber bundle 41, and introduced into the optic spectral system 50, it is possible to obtain intensive Raman scattering signals, and thereby identify the target plastic P in the same way as the previous embodiment.

The matrix arrangement of the plain convex lenses 35a defining the fly-eye lens 35 may be varied to other arrangements in an area into which lights having been collected by the light-collection lens 32 are introduced, in which case, the optical fibers 41a may be arranged in a circle or in a polygon in compliance with the arrangement of the lenses 35a of fly-eye lens 35.

Though not illustrated, a slit may be added downstream of outlet ends of the optical fiber bundles 40 and 41. Since lights having left the optical fiber bundles 40 and 41 through outlet ends thereof at which optical fibers are bundled in the form of a slit are introduced into the optic spectral system 50 through the slit, it is possible to remove stray lights, and hence, enhance a resolution of Raman scattering signals.

Though each of the optical path converters in the first and second embodiments is comprised of the optical fiber bundle 40 and 41, respectively, the optical path converter may be comprised of a monolithic block composed of transparent quartz, glass or plastic, and defining a single optical waveguide which converts lights having been collected by the light-collection system 30 into slit-shaped lights in compliance with an orientation of a diffraction grating of the spectroscope 52.

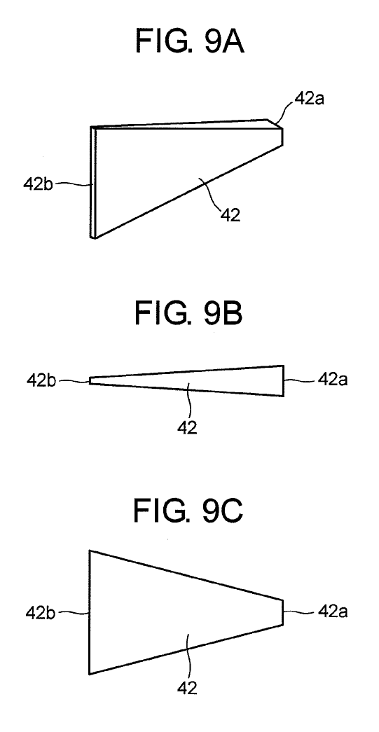

FIGS. 9A, 9B and 9C illustrate an example of such a monolithic block 42.

As illustrated in FIGS. 9B and 9C, the monolithic block 42 has a trapezoidal horizontal cross-section, and a trapezoidal vertical cross-section. The monolithic block 42 is designed to have both an incident end 42a having a shape which is in compliance with a contour of Raman scattering lights generated by irradiation of the laser beams L, and an outlet end 42b which is in the form of a slit in compliance with an orientation of a diffraction grating of the spectroscope 52.

Thus, Raman scattering lights generated by irradiation of excitation laser beams enter the monolithic block 42 through its incident end 42a having a shape which is in compliance with a contour of Raman scattering lights, leave the monolithic block 42 through its outlet end 42b which is in the form of a slit in compliance with an orientation of a diffraction grating of the spectroscope 52, and then, are introduced into the spectroscope 52. Accordingly, it is possible to obtain intensive Raman scattering signals and hence identify the target plastic P without degradation of resolution to a wavelength or a number of waves, which degradation causes a widened width of Raman scattering peaks.

### INDUSTRIAL APPLICABILITY

The apparatus for receiving Raman scattering signals and the method of doing the same, both in accordance with the present invention, are useful for identifying plastics based on Raman scattering in order to non-destructively identify plastics, woods or papers.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2010-181806 filed on Aug. 16, 2010 including specification, claims, drawings and summary is incorporated herein by reference in its entirety.

What is claimed is:

1. An apparatus for receiving Raman scattering signals, comprising:
an optic light-collection system for collecting Raman scattering lights having scattered from an object when excitation laser beams are irradiated thereto;
a spectroscope including a diffraction grating, for separating said Raman scattering lights into its spectral components; and
an optical path converter including at least one optical waveguide for converting lights having been collected by said optic light-collection system into slit-shaped lights in compliance with an orientation of said diffraction grating.

2. The apparatus as set forth in claim 1, wherein said optical path converter has an incident end having a shape in compliance with a contour of said Raman scattering lights.

3. The apparatus as set forth in claim 1, wherein said optic light-collection system includes a light-collecting lens having an irradiation distance for collecting said Raman scattering lights in compliance with an irradiation contour of said excitation laser beams.

4. The apparatus as set forth in claim 1, wherein said optic light-collection system further includes an incidence lens which turns lights collected by said optic light-collection system, into a shape in compliance with a shape of an incident end of said optical path converter.

5. The apparatus as set forth in claim 4, wherein said incidence lens is comprised of a fly-eye lens, and
said incident end of said optical path converter has a shape which is in compliance with said fly-eye lens.

6. The apparatus as set forth in claim 1, further comprising one of a collimator mirror and a collimator lens for introducing lights emitted out of said optical path converter, into said spectroscope.

7. The apparatus as set forth in claim 1, further comprising a slit located downstream of an outlet end of said optical path converter through which lights leave said optical path converter.

8. The apparatus as set forth in claim 1, wherein said excitation laser beams comprise narrow-banded laser beams.

9. The apparatus as set forth in claim 2, wherein said optical path converter includes a plurality of optical fibers, wherein one of said optical fibers is centrally located at said incident end of said optical path converter, and the rest of them surround said one of said optical fibers in a circle.

10. The apparatus as set forth in claim 2, wherein said optical path converter includes a plurality of optical fibers, wherein said optical fibers are arranged in a matrix.

11. The apparatus as set forth in claim 9, wherein said optical fibers are aligned in a line at an outlet end of said optical path converter.

12. The apparatus as set forth in claim 10, wherein said optical fibers are aligned in a line at an outlet end of said optical path converter.

13. The apparatus as set forth in claim 9, wherein said optical fibers are arranged in alternate two rows in a the form of a slit at an outlet end of said optical path converter.

14. The apparatus as set forth in claim 10, wherein said optical fibers are arranged in alternate two rows in a the form of a slit at an outlet end of said optical path converter.

15. A method of receiving Raman scattering signals by separating, by means of a spectroscope, Raman scattering lights which an object emits when excitation laser beams are irradiated thereto, into its spectral components to thereby obtain Raman scattering signals, comprising:
collecting said Raman scattering lights;
converting the thus collected Raman scattering lights into slit-shaped lights in compliance with an orientation of a diffraction grating of said spectroscope; and
introducing said Raman scattering lights into said spectroscope.

16. The method as set forth in claim 15, wherein said Raman scattering lights are collected in the first step in compliance with a contour of said Raman scattering lights.
